(19) United States
(12) Patent Application Publication
(10) Pub. No.: US 2018/0227464 A1
(43) Pub. Date: Aug. 9, 2018

(54) EVENT SPECIFIC DATA CAPTURE FOR MULTI-POINT IMAGE CAPTURE SYSTEMS

(71) Applicant: Livestage Inc., New York, NY (US)

(72) Inventor: Kristopher King, Hermosa Beach, CA (US)

(73) Assignee: Livestage Inc., New York, NY (US)

(21) Appl. No.: 15/943,550

(22) Filed: Apr. 2, 2018

Related U.S. Application Data
(63) Continuation-in-part of application No. 14/941,582, filed on Nov. 14, 2015.
Application No. 14/941,582 is a continuation-in-part of application No. 14/719,636, filed on May 22, 2015.
Application No. 14/719,636 is a continuation-in-part of application No. 14/689,922, filed on Apr. 17, 2015, now abandoned.
Application No. 14/689,922 is a continuation-in-part of application No. 14/687,752, filed on Apr. 15, 2015, now abandoned.
Application No. 14/687,752 is a continuation-in-part of application No. 14/532,659, filed on Nov. 4, 2014, now abandoned.
Application No. 14/532,659 is a continuation-in-part of application No. 14/941,584, filed on Nov. 14, 2015.
Application No. 14/941,584 is a continuation-in-part of application No. 14/754,432, filed on Jun. 29, 2015.
Application No. 14/754,432 is a continuation-in-part of application No. 14/754,446, filed on Jun. 29, 2015.
Application No. 14/754,446 is a continuation-in-part of application No. 14/096,869, filed on Dec. 4, 2013, now abandoned.
(60) Provisional application No. 61/900,093, filed on Nov. 5, 2013.
(60) Provisional application No. 61/981,416, filed on Apr. 18, 2014.
(60) Provisional application No. 61/981,817, filed on Apr. 20, 2014.
(60) Provisional application No. 62/002,656, filed on May 23, 2014.
(60) Provisional application No. 62/080,386, filed on Nov. 16, 2014.
(60) Provisional application No. 62/080,381, filed on Nov. 16, 2014.
(60) Provisional application No. 62/018,853, filed on Jun. 30, 2014.
(60) Provisional application No. 62/019,017, filed on Jun. 30, 2014.

(51) Int. Cl. H04N 5/04; H04N 5/765

(52) U.S. Cl. CPC H04N 5/04; H04N 5/765

(57) ABSTRACT

The present invention provides methods and apparatus for collecting ambient data streams during live performances where the audio and video aspects of the performance are also recorded at multiple points in a specific venue. In some examples, recorded ambient data streams may be mixed with the audio and video streams and broadcast to users.

### FIELD OF THE INVENTION

The present invention relates to methods and apparatus for generating streaming media presentations captured from multiple vantage points. More specifically, the present invention presents methods and apparatus for the capture of performance related data other than video and audio signals. According to various techniques related to multipoint image and audio capture systems, a time sequenced recording of a performance may be streamed as a live broadcast or archived. The time sequenced performance data may be useful to performance broadcasting applications and archival preservation of events.

### BACKGROUND OF THE INVENTION

Traditional methods of viewing image data generally include viewing a video stream of images in a sequential format. The viewer is presented with image data from a single vantage point at a time. Simple video includes streaming of imagery captured from a single image data capture device, such as a video camera. More sophisticated productions include sequential viewing of image data captured from more than one vantage point and may include viewing image data captured from more than one image data capture device.

As video capture has proliferated, popular video viewing forums, such as YouTube™, have arisen to allow for users to choose from a variety of video segments. In many cases, a single event will be captured on video by more than one user and each user will post a video segment on YouTube. Consequently, it is possible for a viewer to view a single event from different vantage points, However, in each instance of the prior art, a viewer must watch a video segment from the perspective of the video capture device, and cannot switch between views in a synchronized fashion during video replay. As well, the location of the viewing positions may in general be collected in a relatively random fashion from positions in a particular venue where video was collected and made available ad hoc. It may be typical that such recordings may also include audio tracks. Hereto, the recordings may be collected in relatively random fashions. Finally, there are other performance related metrics and data that are relevant to an event ranging from environmental data, control sequences, equipment parametric setups and dynamic adjustments and the like.

Consequently, manners to record coordinated and time sequenced collection of the various performance related or performance relevant data that supplement collected video and audio streams may be desirable.

### SUMMARY OF THE INVENTION

Accordingly, the present invention provides methods and apparatus for designing collection schemes for performance data and for the collection and use of performance data in a venue and performance specific manner.

One general aspect may include a method of capturing venue specific recordings of an event, the method may include the step of obtaining spatial reference data for a specific venue. The method may also include creating a digital model of the specific venue. The method may also include selecting multiple points for capture of data in a specific venue; where the data includes ambient data, where ambient data means that data other than audio data and video data. The method may also include placing a connection apparatus at a selected point of capture of data, where the connection apparatus provides a link for a data transfer from an apparatus used to capture the ambient data to a device used to record the ambient data. Other examples of this aspect include corresponding computer systems, apparatus, and computer programs recorded on one or more computer storage devices, each configured to perform the actions of the methods.

Implementations may include one or more of the following features. The method may additionally include the steps of presenting the digital model to a first user, where the presentation supports selecting multiple points for capture of data. The method may include cases where the presentation includes venue specific aspects. The method may include cases where the venue specific aspects include one or more of seating locations, aisle locations, obstructions to viewing, sound control apparatus, sound projection apparatus, and lighting control apparatus. The method may include examples where selecting multiple points for capture of data is performed by interacting with a graphical display apparatus, where the interacting involves placement of a cursor location and selecting of the location with a user action. The method may include cases where the user action includes one or more of clicking a mouse, clicking a switch on a stylus, engaging a keystroke, or providing a verbal command. The method may additionally include the step of presenting the digital model to a second user, where the second user employs the digital model to locate selected data capture locations in a venue. The method may additionally include the step of recording the data from the selected capture location. The method may also include mixing the recording of the data with recordings of audio data and with recordings of image data to create a mixed data stream. The method may also include performing on demand post processing on the mixed data stream in a broadcast truck. The method additionally may include the step of: communicating data from the broadcast truck utilizing a satellite uplink. The method may additionally include the step of transmitting at least a first stream of audio data to a content delivery network. The method may include cases where the connection apparatus performs a wireless broadcast of the data. The method may include cases where the data includes environmental data. The method where the environmental data includes temperature. The method may include cases where the data includes control sequences, where the control sequences affect performance related equipment. The method may include examples where the performance related equipment includes one or more of lighting equipment, audio processing equipment, special effects equipment or stage equipment. The method may additionally include the step of processing a first data stream of the ambient data with an algorithm to synthesize a second data stream. The method may also include examples where the algorithm adjusts an audio stream based upon an ambient data stream. Implementations of the described techniques may include hardware, a method or process, or computer software on a computer-accessible medium.

One general aspect includes a method of collecting ambient data from a performance, the method may include configuring an ambient data collection device in a venue. The method may also include synchronizing collection of data from the ambient data collection device to a time based index. The method may also include recording ambient data and synchronization data. Other examples of this aspect include corresponding computer systems, apparatus, and computer programs recorded on one or more computer storage devices, each configured to perform the actions of the methods.

Implementations may additionally include the step of processing a first data stream of the ambient data with an algorithm to synthesize a second data stream. In addition, the method where the algorithm adjusts an audio stream based upon an ambient data stream may be included. Implementations of the described techniques may include hardware, a method or process, or computer software on a computer-accessible medium.

One general aspect may include a method of capturing venue specific recordings of an event, the method may include the steps of placing multiple points for capture of ambient data in a specific venue. The method may also include placing a connection apparatus at a selected point of capture of data, where the connection apparatus provides a link for a data transfer from an apparatus used to capture the data to a device used to record the data. Other examples of this aspect include corresponding computer systems, apparatus, and computer programs recorded on one or more computer storage devices, each configured to perform the actions of the methods.

### BRIEF DESCRIPTION OF THE SEVERAL VIEWS OF THE DRAWING

The accompanying drawings, that are incorporated in and constitute a part of this specification, illustrate several examples of the invention and, together with the description, serve to explain the principles of the invention:

FIG. 1 illustrates a block diagram of Content Delivery Workflow according to some examples of the present invention.

FIG. 2 illustrates the parameters influencing placement of audio capture devices in an exemplary stadium venue.

FIG. 3 illustrates an exemplary representation of a performance that may relate to some examples of the present invention.

FIG. 4 illustrates exemplary method steps that may be useful to implement some examples of the present invention.

FIG. 5 illustrates apparatus that may be used to implement aspects of the present invention including executable software.

### DETAILED DESCRIPTION OF THE INVENTION

The present invention provides generally for the capture, use and retention of data relating to performances in a specific venue in addition to the visual and sound data that may be recorded. Techniques to record visual and audible data may involve the use of multiple video camera arrays and audio microphones and arrays of audio microphones for the capture and processing of video and audio data that may be used to generate visualizations of live performance sound along with imagery from a multi-perspective reference. There is other data that may be collected and retained that relates to performances. Such data may include in a non-limiting sense, data related to the environment, local and general, of the performance, data related to the control sequences for support equipment, data related to the processing of audio signals and data related to the control of various lighting and special effects.

In the following sections, detailed descriptions of examples and methods of the invention will be given. The description of both preferred and alternative examples though through are exemplary only, and it is understood that to those skilled in the art that variations, modifications and alterations may be apparent. It is therefore to be understood that the examples do not limit the broadness of the aspects of the underlying invention as defined by the claims.

### Definitions

As used herein “Broadcast Truck” refers to a vehicle transportable from a first location to a second location with electronic equipment capable of transmitting captured image data, audio data and video data in an electronic format, wherein the transmission is to a location remote from the location of the Broadcast Truck.

As used herein, “Image Capture Device” refers to apparatus for capturing digital image data, an Image capture device may be one or both of: a two dimensional camera (sometimes referred to as “2D”) or a three dimensional camera (sometimes referred to as “3D”). In some examples an image capture device includes a charged coupled device (“CCD”) camera.

As used herein, “Production Media Ingest” refers to the collection of image data and input of image data into storage for processing, such as Transcoding and Caching. Production Media Ingest may also include the collection of associated data, such a time sequence, a direction of image capture, a viewing angle, 2D or 3D image data collection.

As used herein, “Vantage Point” refers to a location of Image Data Capture in relation to a location of a performance.

As used herein, “Directional Audio” refers to audio data captured from a vantage point and from a direction such that the audio data includes at least one quality that differs from audio data captured from the vantage and a second direction or from an omni-direction capture.

As used herein, “Ambient Data” refers to data and datastreams that are not audio data or video data.

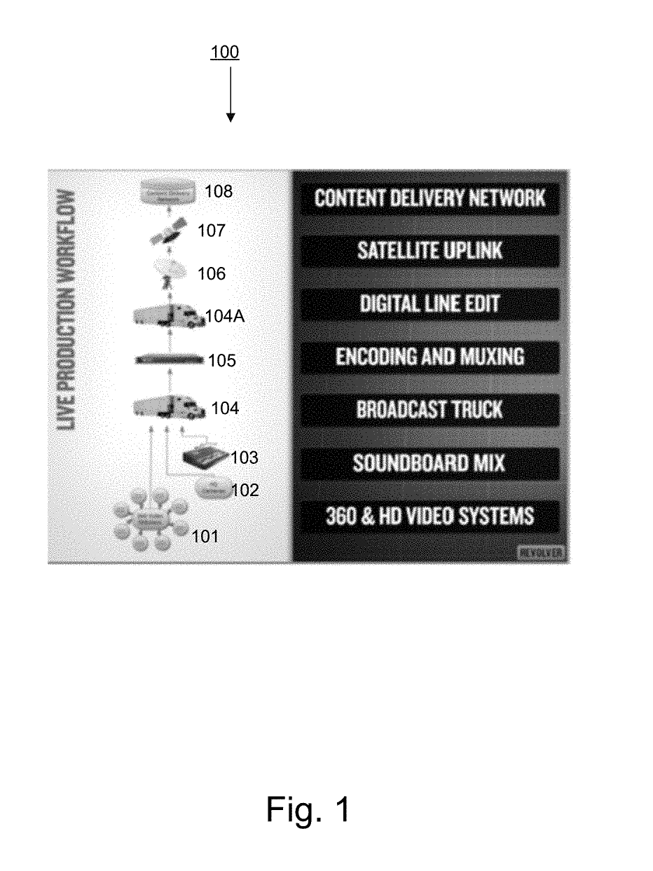

Referring now to FIG. 1, a Live Production Workflow diagram is presented 100 with components that may be used to implement various examples of the present invention. Image capture devices, such as for example, one or both of 360 degree camera arrays 101 and high definition camera 102 may capture image date of an event. In preferred examples, multiple vantage points each may have both a 360 degree camera array 101 and at least one high definition camera 102 capturing image data of the event. Image capture devices may be arranged for one or more of: planer image data capture; oblique image data capture; and perpendicular image data capture. Some examples may also include audio microphones to capture sound input which accompanies the captured image data.

Additional examples may include camera arrays with multiple viewing angles that are not complete 360 degree camera arrays, for example, in some examples, a camera array may include at least 120 degrees of image capture, additional examples include a camera array with at least 180 degrees of image capture; and still other examples include a camera array with at least 270 degrees of image capture. In various examples, image capture may include cameras arranged to capture image data in directions that are planar or oblique in relation to one another.

A soundboard mix 103 may be used to match recorded audio data with captured image data. In some examples, in order to maintain synchronization, an audio mix may be latency adjusted to account for the time consumed in stitching 360 degree image signals into cohesive image presentation.

A Broadcast Truck 104 includes audio and image data processing equipment enclosed within a transportable platform, such as, for example, a container mounted upon, or attachable to, a semi-truck, a rail car; container ship or other transportable platform. In some examples, a Broadcast Truck will process video signals and perform color correction. Video and audio signals may also be mastered with equipment on the Broadcast Truck to perform on-demand post-production processes.

In some examples, post processing 105 may also include one or more of: encoding; muxing and latency adjustment. By way of non-limiting example, signal based outputs of (“High Definition”) HD cameras may be encoded to predetermined player specifications. In addition, 360 degree files may also be re-encoded to a specific player specification. Accordingly, various video and audio signals may be muxed together into a single digital data stream. In some examples, an automated system may be utilized to perform muxing of image data and audio data.

In some examples, a Broadcast Truck 104A or other assembly of post processing equipment may be used to allow a technical director to perform line-edit decisions and pass through to a predetermined player's autopilot support for multiple camera angles.

A satellite uplink 106 may be used to transmit post process or native image data and audio data. In some examples, by way of non-limiting example, a muxed signal may be transmitted via satellite uplink at or about 80 megabytes (Mb/s) by a commercial provider, such as, PSSI Global™ or Sureshot™ Transmissions.

In some venues, such as, for example events taking place at a sports arena a transmission may take place via Level 3 fiber optic lines, otherwise made available for sports broadcasting or other event broadcasting. Satellite Bandwidth 107 may be utilized to transmit image data and audio data to a Content Delivery Network 108.

As described further below, a Content Delivery Network 108 may include a digital communications network, such as, for example, the Internet. Other network types may include a virtual private network, a cellular network, an Internet Protocol network, or other network that is able to identify a network access device and transmit data to the network access device. Transmitted data may include, by way of example: transcoded captured image data, and associated timing data or metadata.

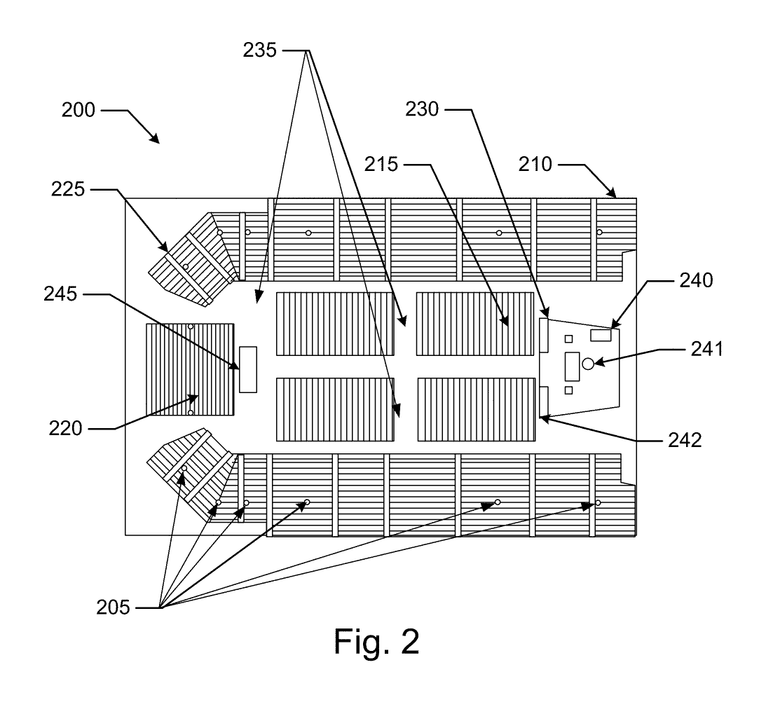

Referring to FIG. 2, a depiction of an exemplary stadium venue 200 with various features delineated may be found in a top-down representation. In a general perspective the types of venues may vary significantly and may include rock clubs, big rooms, amphitheaters, dance clubs, arenas and stadiums as non-limiting examples. Each of these venue types and perhaps each venue within a type may have differing acoustic characteristics and different important locations within a venue. Importantly to the discussions herein, each venue and venue type may have unique ambient data aspects that may be important to the nature of the performance, where ambient data refers to data or datastreams that are that data other than audio and video data. Collection of some of this data may be performed by accessing or locating equipment containing sensors of various kinds with or near specific locations used to record visual and audio during a performance. Alternatively, the collection may occur through or with the unique building and venue specific systems that support a performance.

As a start, it may be useful to consider the various types of locations that may occur in an exemplary venue. At exemplary venue 200 a depiction of a stadium venue may be found. A stadium may include a large collection of seating locations of various different types. There may be seats 215 such as those surrounding region that have an unobstructed close view to the stage 230 or other performance venue. The audio and video characteristics of these locations may be relatively pure, and ideal for audio as well since the distance from amplifying equipment is minimal. Other seats such as region 210 may have a side view of the stage 230 or in other examples the performance region. Depending on the nature of the deployment of audio amplifying equipment and of the acoustic performance of the venue setting, such side locations may receive a relatively larger amount of reflected and ambient noise aspects compared to the singular performance audio output. Some seating locations such as region 225 may have obstructions including the location of other seating regions. These obstructions may have both visual and audio relevance. A region 220 may occur that is located behind and in some cases obstructed by venue control locations such as sound and lighting control systems 245. The audio results in such locations may have impact of their proximity to the control locations. The venue may also have aisles 235 such as where pedestrian traffic may create intermittent obstruction to those seating locations there behind. The visual and acoustic and background noise aspects of various locations within a venue may be relevant to the design and placement of equipment related to the recording of both visual and audio signals of a performance.

In some examples, the location of recording devices may be designed to include different types of seating locations. There may be aspects of a stadium venue that may make a location undesirable as a design location for audio and video capture. At locations 205 numerous columns are depicted that may be present in the facility. The columns may have visual or acoustic impact but may also afford mounting locations for audio and video recording equipment where an elevated location may be established without causing an obstruction in its own right. There may be other features that may be undesirable for planned audio and video capture locations such as behind handicap access, behind aisles with high foot traffic, or in regions where external sound or other external interruptive aspects may impact a desired audio and video capture.

The stage 230 or performance region may have numerous aspects that affect audio and video collection. In some examples, the design of the stage may place performance specific effects on a specific venue. For example, the placement of speakers, such as that at location 242 may define a dominant aspect of the live audio and video experienced at a given location within the venue. The presence of performance equipment such as, in a non-limiting sense, drum equipment 241 may also create different aspects of the sound profile emanating from the stage. There may be sound control and other performance related equipment 240 on stage that may create specific audio and video and audio and video retention based considerations. It may be apparent that each venue may have specific aspects that differ from other venues even of the same type, and that the specific stage or performance layout may create performance specific aspects in addition to the venue specific aspects.

A stadium venue may have rafters and walkways at elevated positions. In some examples such elevated locations may be used to support or hang audio and video devices from. In some examples, apparatus supported from elevated support positions such as rafters may be configured to capture audio and video data while moving.

It may be apparent that specific venues of a particular venue type may have different characteristics relevant to the placement of audio and video capture apparatus. For other types of data collection, these locations for audio and video capture apparatus may be default locations. In a non-limiting sense, there may be temperature, pressure, humidity and other environmental sensors that may be collocated at the video and audio collection locations. There may be other locations as well where such environmental sensing apparatus is placed. Although, the multi-location video data streams may be useful to triangulate locations of sensing equipment, the exact location of the equipment may be calculated, sensed or measured by various techniques and may comprise other types of data that may be recorded in the recording of a performance. Environmental data as an example may provide parametric values that may be useful in algorithmic treatment of recorded data or be of interest from a historical recording perspective. There may also be control streams of data that are sent to the audio and video recording systems such as external directional signals, focusing, zoom, filtering and the like. These control signals may also comprise data streams that may be collected and recorded along a time sequence. There may be other control signals that operate during a performance, and the collection of these data streams will be discussed in later sections.

It may be further apparent that different types of venues may also have different characteristics relevant to the placement of the audio and video capture apparatus as well as the other types of data streams. In a similar vein, since the location of some ambient data collection equipment may in some examples mirror the placement of image capture apparatus, the aspects of a venue related to image capture may create default locations for other data capture. In some examples, the nature and location of regions in a specific venue, including venue installed ambient sensors, may be characterized and stored in a repository. In some examples, the venue characterization may be stored in a database. The database may be used by algorithms to present a display of a seating map of a specific venue along with the types of environmental sensors and control systems that may be found within the venue. In some examples, the display of various ambient data collection apparatus characteristics and locations may be made via a graphical display station connected to a processor.

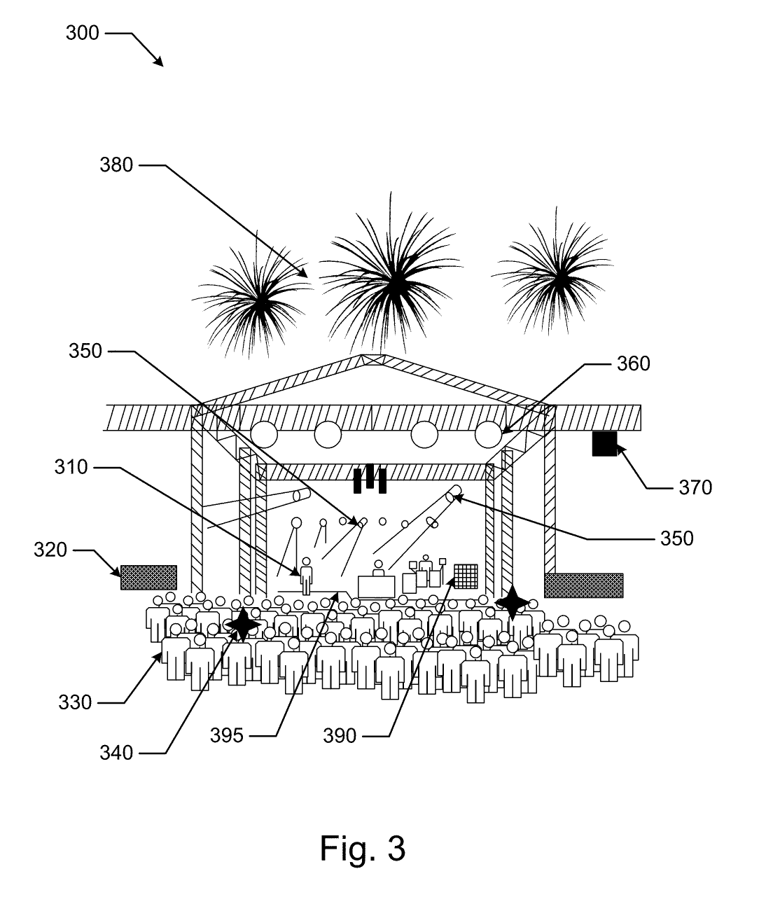

Referring to FIG. 3, a representation of a specific exemplary performance setting 300 that may occur in an exemplary venue as demonstrated at 200 is depicted to assist in the description of other types of data such as environmental and control data sequences that may be recorded during a live performance. A performer 310 may be located on a performance stage of the venue. The performer may be wearing apparatus that records audio signals around him. The same equipment or other equipment may not only broadcast the recorded audio to transceivers in the venue, but also may provide data information of the location of the performer. In some embodiments such information may be useful to control other systems in the venue such as lighting systems depicted at 350. Control systems may be programmed how to respond to the location of performers. These ambient data signals may be recorded in a live performance recording stream as well as the subsequent control sequences that are sent to the lighting systems 350. As well, the programming sequences may also comprise ambient data that may be recorded.

Audio amplification systems 320, for example, may comprise systems that have other types of data streams that may be recorded. The audio amplification systems may have adjustable amplification levels that may be sent to them. As well as different filtering treatments, other synthesis may occur and involve aspects such as sound effects of various kinds, auto tuning and the like. The locations of the audio equipment may also comprise locations for environmental sensors as have been described. There may be other types of data that are available and may be recorded according to the concepts described herein.

Spectators 330 may have various data collection equipment upon them as well. For example, smart phones may be used by spectators to communicate various types of information to websites, social media and the like. When permitted by the users and others, these data streams may include information recorded in a live performance recording. These devices may also collect other information that when permitted may be recorded as well. Some spectators may be permitted to record audio and video data streams that may be collected as part of the data collection scheme.

At the locations indicated by a star, two examples of the multi-location recording locations for audio or video may be presented. As has been mentioned in addition to the audio and or video data collected at these locations 340 there may be various other data relating to the performance of the equipment, monitoring of environmental or situational data as well as location information. These examples are some of the types of data that may be collected, in a non-limiting sense.

Lighting and light effects, such as depicted at 350 may comprise a type of data collection nodes that may have numerous types of collection. For example, the lights may be mounted on motor driven axial mounts that allow the lights to be directed and focused upon specific directions and locations by electrical signals or data controlled signals. These signals may be recorded as part of the data collection of a live performance event. In some examples, the collection may occur at the singular device itself, while in other examples the control systems for the light systems may be the prime location for the recording of the control signal data to these types of systems.

Another type of lighting system 360 may be lighting that does not focus on particular elements of the performance but creates part of the show or ambience. Other examples of these types of light displays may be display panels that present video, textual or other types of display. Alternatively, in other examples, lighting effects such as laser light shows may be included at a performance. In a similar manner to the discussion of the other lighting examples, data associated with the control and performance of these systems may be recorded either or both as the direct stream or as the programming sequences. Again, as may be common with all the other types of data recording discussed herein, the data recording may occur with reference to a universal time sequence, so that the recorded data may be associated with any of the other various types of collected data in a simultaneous manner.

There may be venue, or performance specific monitoring systems 370. These systems may record environmental data as an example. In internal events, these recordings may include temperature, humidity, pressure, and in examples of external events may also include such sensing as wind speeds, wind directions, ambient light, air clarity and the like. These parameters may be relevant to numerous algorithmic treatments of recorded data of various kinds and may be useful for synthesizing or adjusting aspects of the recorded data where a time sequenced access to the parametric data may be accessed by the devices performing the algorithmic processing on the data.

There may be many types of special effects that are programmed into a performance. In a non-limiting example fireworks may be an example of a special effect 380 however there may be numerous other examples including, gas flames, confetti, balloon drops, and special effects of other types. The control sequences for these effects may also be recorded in a time sequenced manner and comprise some of the live performance recording information. In some examples, these signals may be useful in a location displaying a live event to invoke simulation of the various effects in the environment of display systems. In other examples, the historical record of a performance may be useful for such purposes as event reenactment, or analysis of success of the effect to that intended during the performance.

There may be devices that coordinate the collection of audio signals 390 and coordinate synthetic adjustments of various kinds, as well as sound effects of various kinds. The control aspects of these devices as well as raw performance aspects of the equipment such as amplification levels achieved for various set points as an example may be recorded.

In still further examples, the stage 395 may in some cases have active aspects to it in that some or all of the stage may move dynamically during a performance. The signals recorded during these movements may be derived from sensors on the stage equipment or may be the control signals to the stage equipment itself. In other examples, other aspects of stage or performance movement may have control systems that are recorded in the various mentioned manners. Performers may be moved on support systems or wires, shades or screens or curtains may be moved in various manners as some examples.

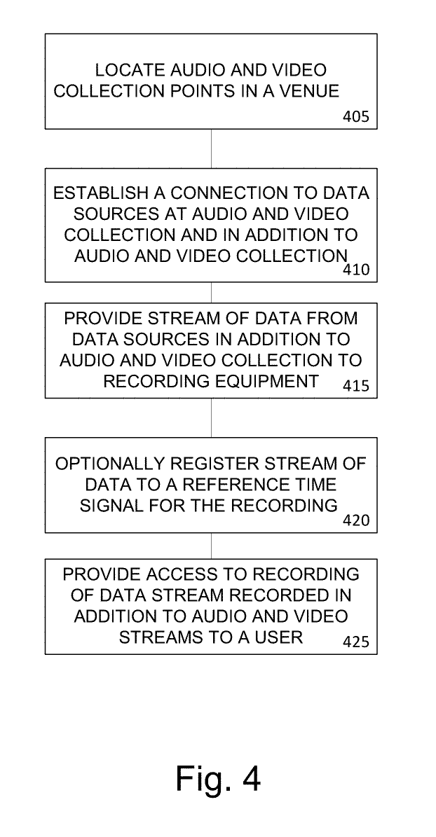

Referring to FIG. 4, there may be numerous methods relating to the recording of ambient data from a live performance at a specific venue. These methods may share some or all of a select set of common steps. In FIG. 4, these common steps may be depicted. A multi-viewpoint recording of a live performance will typically involve the placement of equipment 405 of various types to record video and audio from defined points in a venue. As mentioned previously these defined locations may also be a subset of the various locations that have ambient data. Methods according to the present invention may involve the establishment of connections 410 to these various data sources with recording equipment. There have been numerous descriptions of the various types of data sources where this connection may be established. The connection may be of wired or wireless types. The connection may use its own infrastructure, or in other examples may piggyback onto infrastructure used to connect audio and video recording equipment to recording equipment. As discussed in reference to FIG. 1, the recording equipment may be useful in the broadcasting of the recorded data to end users. And, the stream of data from these data sources in addition to audio and video sources may be connected 415 to the recording/broadcasting equipment.

In some examples, the recording or rebroadcasting equipment may generate or have access to a timing standard that can be simultaneously defined into the data streams of various types. In some examples a default timing may be defined based on the coincidence of the recording and broadcasting of the various data. In other examples, the various data streams may have a timing data stream embedded within the main data stream. In some methods, the data stream originating from data sources other than audio and video related sources may include the embedded timing data stream 420.

In some examples, the recorded and broadcasted live performance data streams may be provided to users of the live performance data event. The users of this data may receive access of various types to the data. Select vantage points may be provided, or select types of video and audio collection may be provided, and for the type of data discussed herein, portions or all of these other data streams may also be provided to end users 425. There may be numerous uses for this provided data including the use of control signals from the live performance to cause effects of various kinds at a viewing location remote from the performance. The provided data may also be used by algorithms of various types that may operate upon data processing equipment remote from the live performance venue; wherein the algorithms may use the other types of data to adjust calculations of various kinds in the creation of synthesis or other effects to audio or video signals.

### Apparatus

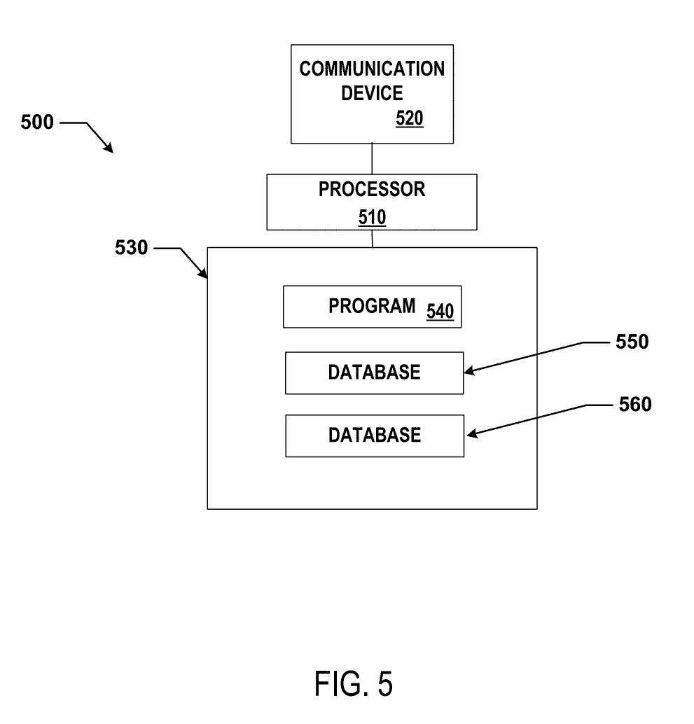

In addition, FIG. 5 illustrates a controller 500 that may be utilized to implement some examples of the present invention. The controller may be included in one or more of the apparatus described above, such as the Revolver Server, and the Network Access Device. The controller 500 comprises a processor 510, such as one or more semiconductor based processors, coupled to a communication device 520 configured to communicate via a communication network (not shown in FIG. 5). The communication device 520 may be used to communicate, for example, with one or more online devices, such as a personal computer, laptop or a handheld device.

The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 can store a software program 540 for controlling the processor 510. The processor 510 performs instructions of the software program 540, and thereby operates in accordance with the present invention. The processor 510 may also cause the communication device 520 to transmit information, including, in some instances, control commands to operate apparatus to implement the processes described above. The storage device 530 can additionally store related data in a database 550 and database 560, as needed.

### Conclusion

A number of examples of the present invention have been described. While this specification contains many specific implementation details, they should not be construed as limitations on the scope of any inventions or of what may be claimed, but rather as descriptions of features specific to particular examples of the present invention.

Certain features that are described in this specification in the context of separate examples can also be implemented in combination in a single embodiment. Conversely, various features that are described in the context of a single embodiment can also be implemented in combination in multiple examples separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the examples described above should not be understood as requiring such separation in all examples, and it should be understood that the described program components and systems can generally be integrated together in a single software product or packaged into multiple software products.

Thus, particular examples of the subject matter have been described. Other examples are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

1. A method of capturing venue specific recordings of an event, the method comprising the steps of:
obtaining spatial reference data for a specific venue;
creating a digital model of the specific venue;
selecting multiple points for capture of data in a specific venue; wherein the data comprises ambient data; and
placing a connection apparatus at a selected point of capture of data, wherein the connection apparatus provides a link for a data transfer from an apparatus used to capture the data to a device used to record the data.

2. The method of claim 1 additionally comprising the steps of:
presenting the digital model to a first user, wherein the presentation supports selecting multiple points for capture of data.

3. The method of claim 2 wherein the presentation includes venue specific aspects.

4. The method of claim 3 wherein the venue specific aspects include one or more of seating locations, aisle locations, obstructions to viewing, sound control apparatus, sound projection apparatus, and lighting control apparatus.

5. The method of claim 4 wherein selecting multiple points for capture of data is performed by interacting with a graphical display apparatus, wherein the interacting involves placement of a cursor location and selecting of the location with a user action.

6. The method of claim 5 wherein the user action includes one or more of clicking a mouse, clicking a switch on a stylus, engaging a keystroke, or providing a verbal command.

7. The method of claim 3 additionally comprising the step of presenting the digital model to a second user, wherein the second user employs the digital model to locate selected data capture locations in the specific venue.

8. The method of claim 7 additionally comprising the steps of:
recording the data from the selected capture location;
mixing the recording of the data with recordings of audio data and with recordings of image data to create a mixed data stream; and
performing on demand post processing on the mixed data stream in a broadcast truck.

9. The method of claim 8 additionally comprising the step of:
communicating data from the broadcast truck utilizing a satellite uplink.

10. The method of claim 9 additionally comprising the step of:
transmitting at least a first stream of audio data to a content delivery network.

11. The method of claim 2 wherein the connection apparatus performs a wireless broadcast of the data.

12. The method of claim 2 wherein the data includes environmental data.

13. The method of claim 12 wherein the environmental data includes temperature.

14. The method of claim 2 wherein the data includes control sequences, wherein the control sequences affect performance related equipment.

15. The method of claim 14 wherein the performance related equipment includes one or more of lighting equipment, audio processing equipment, special effects equipment or stage equipment.

16. A method of collecting ambient data from a performance, the method comprising:
configuring an ambient data collection device in a venue;
synchronizing collection of data from the ambient data device to a time based index; and
recording ambient data and ambient data related synchronization data.

17. The method of claim 16 additionally comprising the steps of:
processing a first data stream of the ambient data with an algorithm to synthesize a second data stream.

18. The method of claim 17 wherein the algorithm adjusts an audio stream based upon ambient data stream.

19. A method of capturing venue specific recordings of an event, the method comprising the steps of:
placing multiple points for capture of ambient data in a specific venue; and
placing a connection apparatus at a selected point of capture of data, wherein the connection apparatus provides a link for a data transfer from an apparatus used to capture the ambient data to a device used to record the data.
